(19) United States
(12) Patent Application Publication
(10) Pub. No.: US 2019/0070812 A1
(43) Pub. Date: Mar. 7, 2019

(54) METHOD OF BUILDING A TIRE

(71) Applicant: The Goodyear Tire & Rubber Company, Akron, OH (US)

(72) Inventors: George Michael STOILA, Tallmadge, OH (US); Michael James HOGAN, Tallmadge, OH (US); Frank Anthony KMIECIK, Akron, OH (US); Minwu YAO, Hudson, OH (US); Mark John MONTGOMERY, Rootstown, OH (US); Kristian Daniel JOHNSON, North Canton, OH (US); John Edward ANDERSON, Atwater, OH (US); Richard David VARGO, Cuyahoga Falls, OH (US); Pablo Rafael MORALES, Brimfield, OH (US); Andrew Robert ONDO, Pulaski, PA (US)

(21) Appl. No.: 15/693,776

(22) Filed: Sep. 1, 2017

(51) Int. Cl. B29D 30/24

(52) U.S. Cl. CPC B29D 30/246; B29D 2030/2664

(57) ABSTRACT

A method of building a tire on a second stage tire building drum is disclosed. The method employs the steps of mounting a green cylindrically shaped tire carcass onto a tire building drum so that each bead are seated in a respective bead pocket segment, inflating the carcass under low pressure and expanding the carcass into engagement with tread and belt assembly while allowing the one or more of the hubs or one or more of the bead pocket segments to freely slide in the axial direction.

### FIELD OF THE INVENTION

The invention relates to building tires, and more particularly to a method for shaping tires.

### BACKGROUND OF THE INVENTION

The manufacture of tires typically involves a tire building drum wherein numerous tire components are applied to the drum in sequence, forming a cylindrical shaped tire carcass. The tire building drum may be a flat drum, unistage drum, a first stage drum or a high crown tire building drum. In either case, tire components are added onto the drum in succession in order to form a cylindrically shaped first stage green carcass. Next a shaping operation is performed to transform the cylindrical green carcass into a toroidally shaped green tire. Inherent stresses are often created in the green tire, particularly in the apex, bead area and sidewall due to the compression forces and compound strain applied to the carcass in order to transform the components into the desired toroidal shape. These inherent residual stresses can cause tire non-uniformity, poor handling and lower rolling resistance. Thus, an improved tire building process is thus desired that minimizes the residual tire building stresses resulting in an improved tire is desired.

### SUMMARY OF THE INVENTION

The invention provides in a first aspect a method of building a tire carcass on a tire building drum. The method comprises the steps of: applying the green tire carcass onto the tire building drum by placing a first and second bead onto a first and second bead receiving member of the tire building drum, wherein no bead locking force is utilized; inflating the carcass into engagement with a belt and tread package while at least one of the beads is free to move axially inward.

The invention provides in a second aspect a method of forming a tire on a tire building drum comprising the steps of: applying a green tire carcass onto the tire building drum by placing a first and second bead onto a first and second respective bead pocket of the tire building drum, wherein low bead locking force is utilized; wherein at least one of the first and second respective bead pockets are configured for unconstrained sliding in the axial direction; inflating the carcass into engagement with a belt and tread package while the at least one of the bead pockets is free to slide axially inward.

### Definitions

For ease of understanding this disclosure, the following items are defined:

“Apex” means an elastomeric filler located radially above the bead and interposed between the plies and the ply turn-up.

“Axial” and “axially” means the lines or directions that are parallel or aligned with the longitudinal axis of rotation of the tire building drum.

“Bead” means that part of the tire comprising an annular tensile member commonly referred to as a “bead core” wrapped by ply cords and shaped, with or without other reinforcement elements such as flippers, chippers, apexes, toe guards and chafers, to fit the design rim.

“Belt Structure” or “Reinforcing Belts” means at least one annular layer or plies of parallel cords, woven or unwoven, underlying the tread and unanchored to the bead.

“Carcass” means an unvulcanized laminate of tire ply material and other tire components cut to length suitable for splicing, or already spliced, into a cylindrical or toroidal shape. Additional components may be added to the carcass prior to its being vulcanized to create the molded tire.

“Casing” means the tire carcass and associated tire components excluding the tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the plies in the tire are comprised.

“Equatorial Plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Insert” means an elastomeric member used as a stiffening member usually located in the sidewall region of the tire.

“Ply” means a continuous layer of rubber-coated parallel cords.

“Radial” and “radially” mean directions radially toward or away from the axis of rotation of the tire building drum.

“Radial Ply Tire” means a belted or circumferentially restricted pneumatic tire in which at least one layer of ply has the ply cords extend from bead to bead at cord angles between 65° and 90° with respect to the equatorial plane of the tire.

“Shoulder” means the upper portion of sidewall just below the tread edge.

“Sidewall” means that portion of a tire between the tread and the bead.

“Tread” means a rubber component which when bonded to a tire carcass includes that portion of the tire that come into contact with the road when the tire is normally inflated and under normal load.

“Tread Width” means the arc length of the tread surface in the axial direction, that is, in a plane parallel to the axis of rotation of the tire.

### BRIEF DESCRIPTION OF THE DRAWINGS

The invention will be described by way of example and with reference to the accompanying drawings in which:

FIG. 1A is a front perspective view of a second stage tire building drum.

FIG. 1B is a close up perspective view of the hub of the tire building drum of FIG. 1A.

FIG. 2 is a side view of a hub of the tire building drum shown in FIG. 1B and positioned in a axially outward position and with the bead seal removed;

FIG. 3 is a side view of the hub of FIG. 2 shown in a axially inward position and with an optional pusher plate.

FIG. 4 is a rear perspective view of the hub of FIG. 3 shown with the optional pusher plate.

FIG. 5 is a cross-sectional view of the hub of FIG. 4 in the direction 5-5.

FIG. 6A is a cross-sectional view of the hub of FIG. 4 in the direction 6-6.

FIG. 6B is a close-up view of the bead pocket seal.

FIG. 7A is a view of the hub retraction mechanism in a retracted position and FIG. 7B is the hub retraction mechanism in the unretracted position.

FIG. 8A is a closeup view of a bead portion of a green tire carcass mounted in the bead pocket, while FIG. 8B is a close-up view of the bead of the green tire carcass. after the intended rotation of the bead area after shaping the carcass, and the bead position has moved from front of pocket to rear of pocket.

FIG. 9A is a perspective view of the hub shown with the bead lock mechanism retracted, while FIG. 9B illustrates the bead lock mechanism in the radially expanded position.

FIG. 10 is a cross-sectional view of the green tire carcass mounted in the bead pockets of the tire drum.

FIG. 11 illustrates the carcass undergoing low pressure, high volume shaping before the tread and belt package is applied.

FIG. 12 illustrates the green tire carcass inflating into the belt and tread package, with the green tire carcass shown in phantom.

FIG. 13 illustrates the tire formed by shaping and inflation, with the green tire carcass shown in phantom.

### DETAILED DESCRIPTION OF THE INVENTION

The invention provides a new and improved tire building drum that reduces the residual stresses in the green tire carcass, resulting in an improved tire. The process provides that the tire ply and components are shaped into a catenary structure. A catenary structure is a structure that has no tensile or compressive reactions at the base of the structure, and has uniform strain along the length of the structure. In the case of a tire, the beads are the base of the structure and the length from the bead to the crown has uniform strain.

The tire building drum of the present invention allows the tire to be built into a catenary shape, producing a tire that has a bead area and sidewall made with minimal strain. The tire building drum allows the tire to be built so that the ply cords that have the shortest cord length which are maintained in tension, and not compression. The tire building drum also prevents ply cord trisomy, or the unravelling of the cords due to the cords being loaded in compression and not tension.

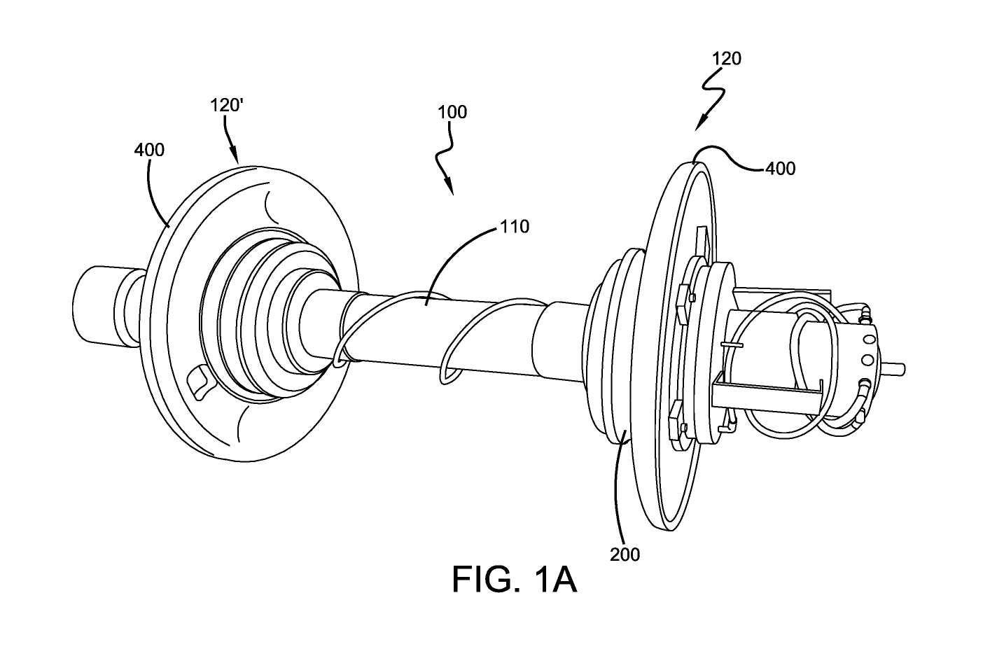

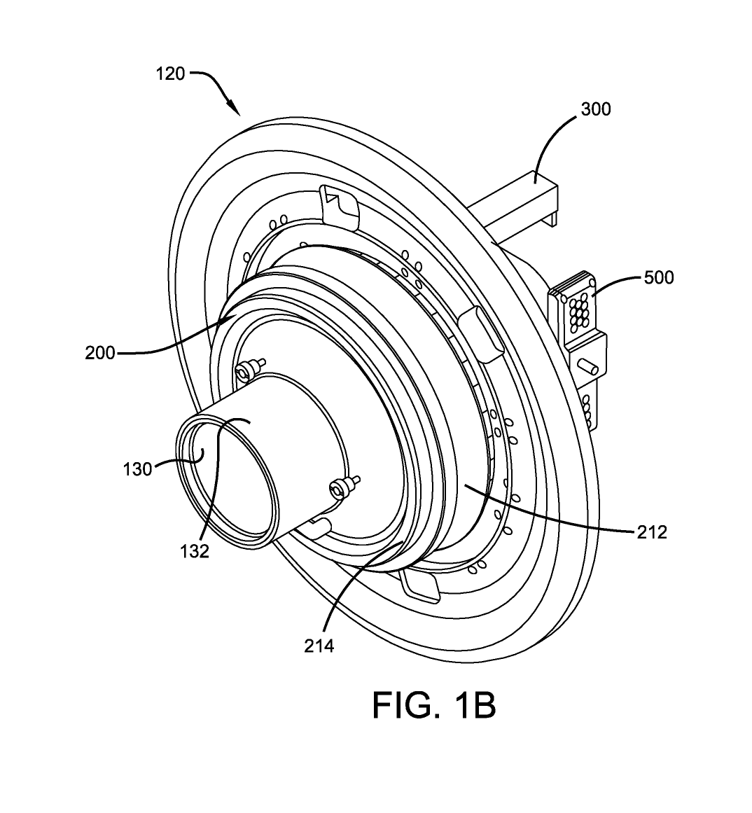

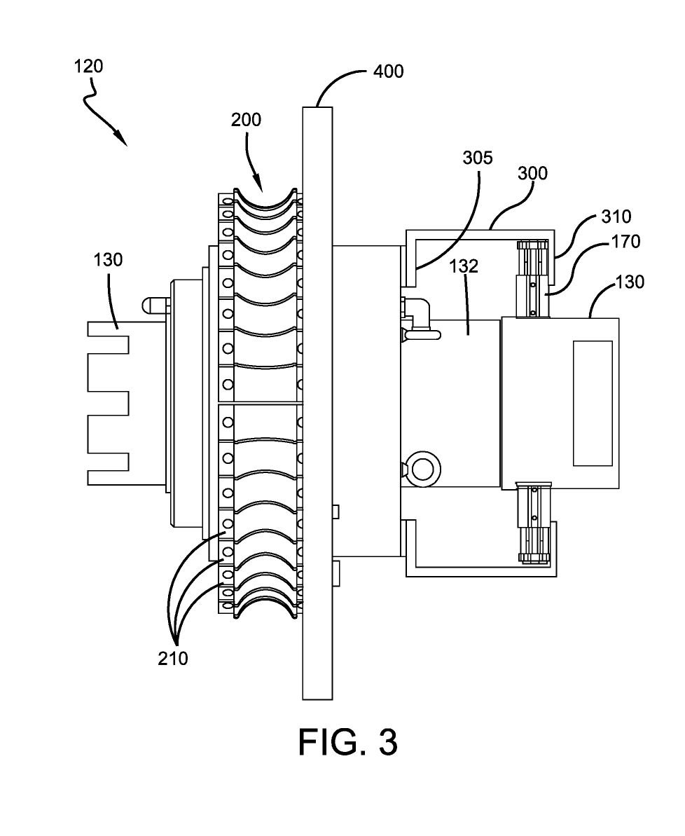

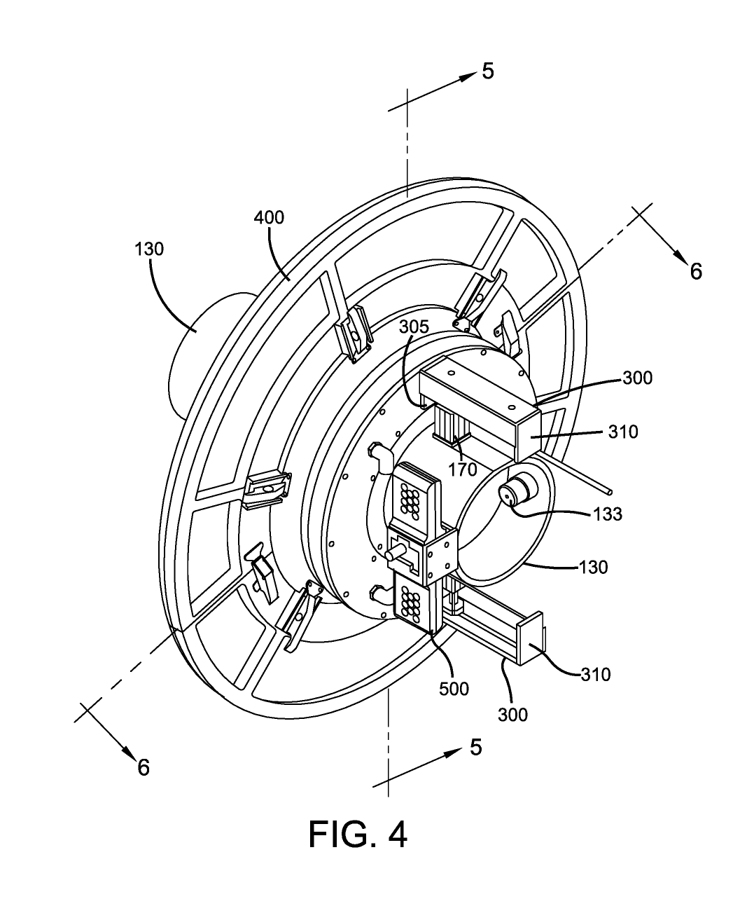

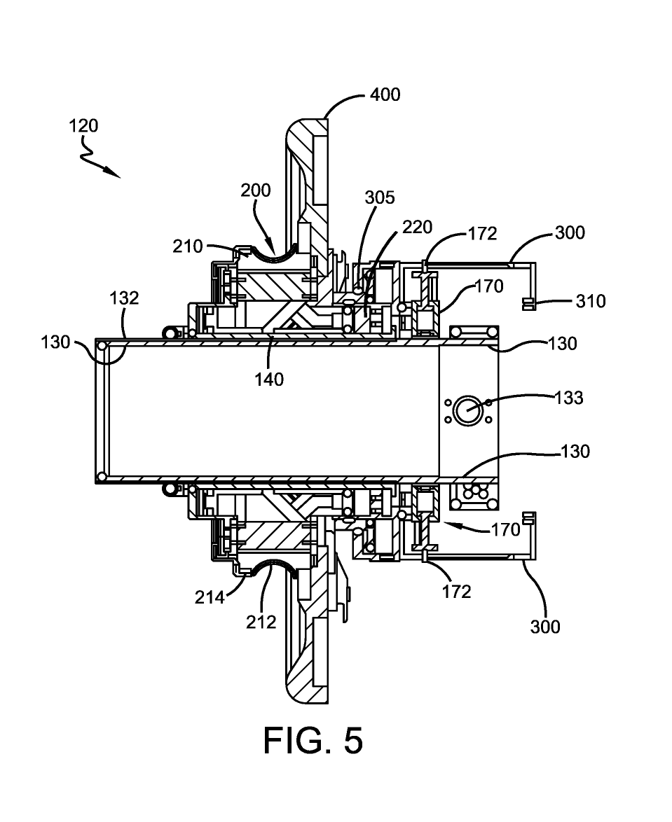

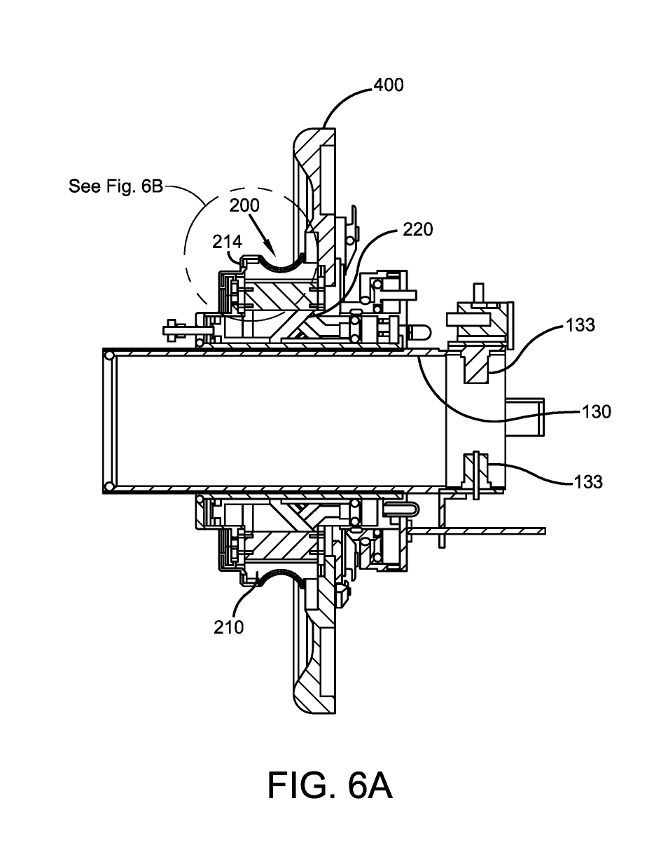

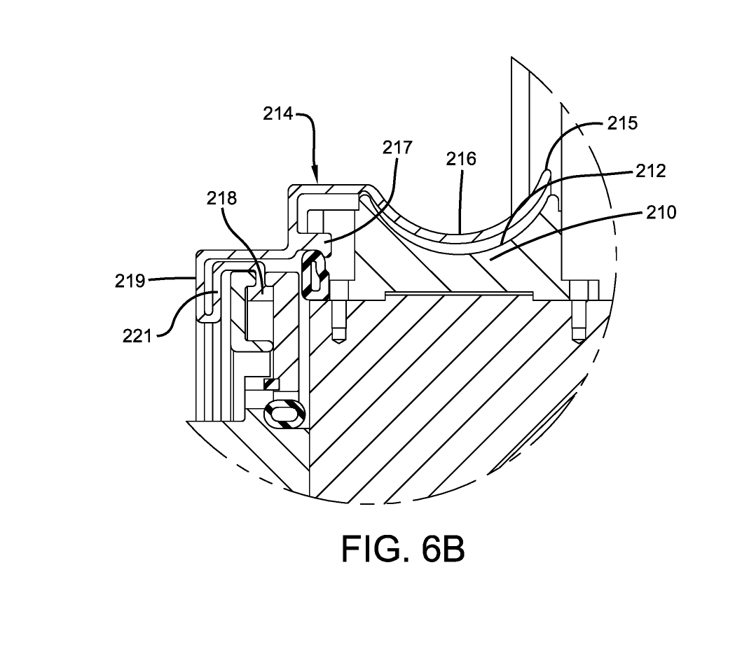

A first embodiment of a second stage tire building drum 100 of the present invention is shown in FIG. 1. The tire building drum 100 has a central shaft 110 with a left hub 120′ and a right hub 120 mounted on the central shaft 110. The left hub 120′ is the mirror image of the right hub 120, and are otherwise mechanically identical except for the orientation. As shown in FIG. 1B and FIGS. 2-4, each hub 120,120′ has an inner sleeve 130 that is secured to a central shaft 110 of the tire building drum. The inner sleeve 130 is connected to an internal screw (not shown) with T bolts 133, so that the inner sleeve 130 may be moved in the axial direction by the internal screw. A sliding sleeve 140 is positioned over the inner sleeve 130. It is preferred that the inner sleeve 130 be bronze on steel with labyrinth grooves and glide ring seals. As shown in FIGS. 5-6, each sliding sleeve 140 slides axially along the inner sleeve 130 so that the hubs 120,120′ slide axially inward towards each other or axially outward from each other. The sliding sleeve 140 may be locked into an axial position by locking cylinders 170. The locking cylinders 170 are mounted on the inner sleeve 130, and have a locking member 172 positioned for engagement with retaining bracket 300. A first end 305 is secured to the sliding sleeve assembly 140. A second distal end 310 of the retaining bracket 300 functions as an axial stop when the distal end engages the locking member 172, as shown in FIG. 3.

Each sliding sleeve 140 further includes a bead lock mechanism 200 for receiving the bead area of the green carcass. Each bead lock mechanism 200 further includes a plurality of bead segments 210. Each bead segment 210 may expanded and contracted in a radial direction by bead actuating cylinders 220. Each bead locking mechanism 200 preferably utilizes zero or low pressure. Preferably the bead lock cylinder pressures range from zero to less than 5 bar, and more preferably from zero to 2 bar. Preferably the force from the bead pockets is less than 30 psig over the projected area of the bead face. The nonexistent or substantially reduced bead pressure is reduced to limit bead compression and prevent cold forging of the toe guard and chafer under the bead sole.

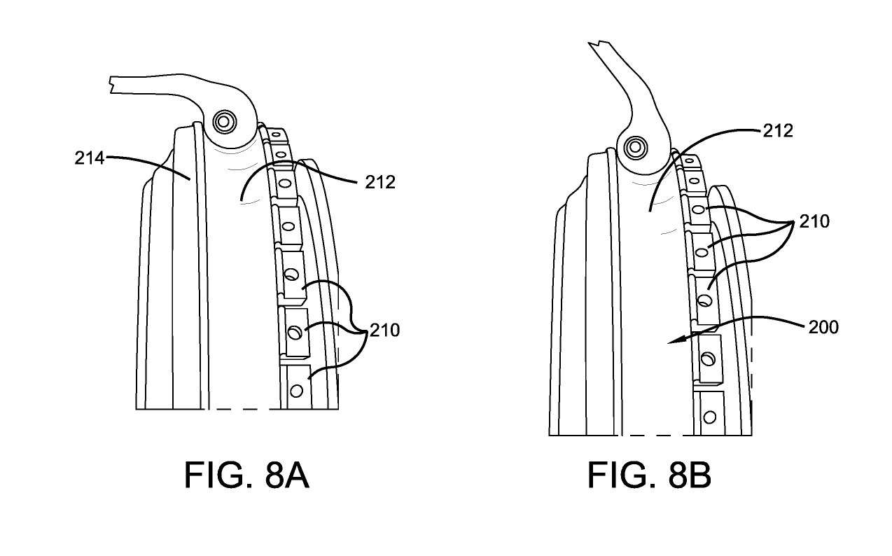

As shown in FIG. 5, each bead segment 210 has a curved or concave pocket 212 that facilitates rotation of the bead area of the tire during shaping. Each curved pocket 212 gently holds and supports the bead without the need of any bead lock force, although low bead lock force can be used. The curved pockets 212 allow the tire to rotate around the bead cable so that the tire down ply is put into tension and the apex is positioned at the cured ply line angle. FIG. 8A illustrates the bead positioned in the curved pocket 212, showing the initial bead position prior to shaping. FIG. 8B illustrates the bead position in the curved pocket 212 after shaping. The curved pocket 212 may be symmetrical or asymmetrical in shape. A flexible annular seal 214 is seated over the pocket 212. As shown in FIGS. 6A and 6B, the flexible seal 214 has a first end 218 that is secured to the housing of the bead pocket. The seal 214 has overlapping portions 219 and 221. The seal further includes a foot 217 that is received within a groove of the housing. The seal has a curved portion 216 that is seated in the pocket 212. The seal terminates in a free end 215. The free end is not secured, and floats, resulting in good sealing with no large forces required by the bead lock cylinder to open the bead pockets and over come the seal restrictive forces.

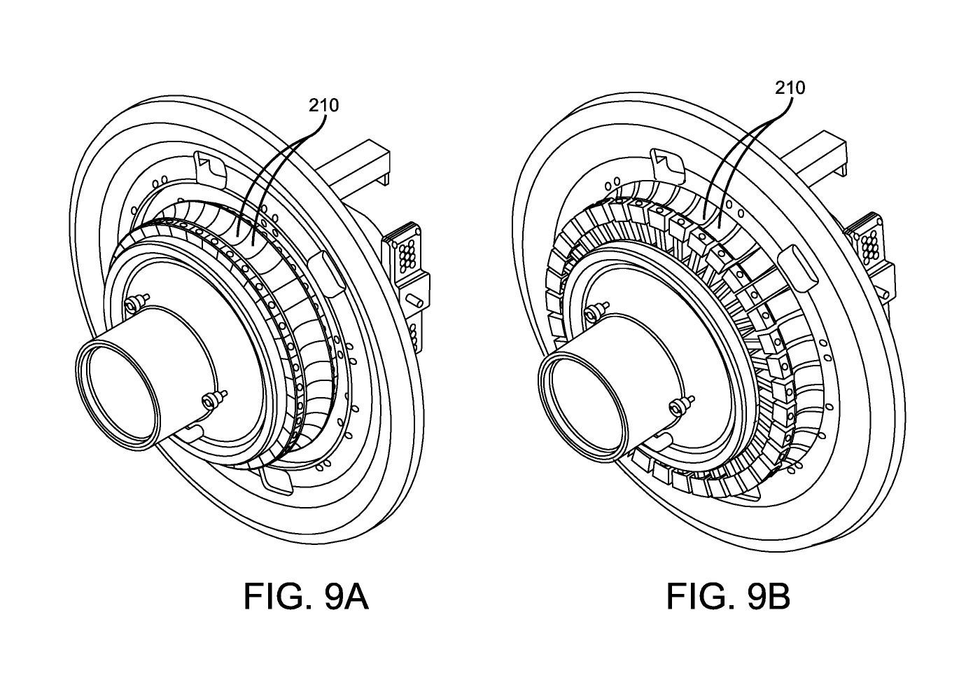

FIG. 9A illustrates the bead segments in the retracted position, while FIG. 9B illustrates the bead segments in their radially expanded position.

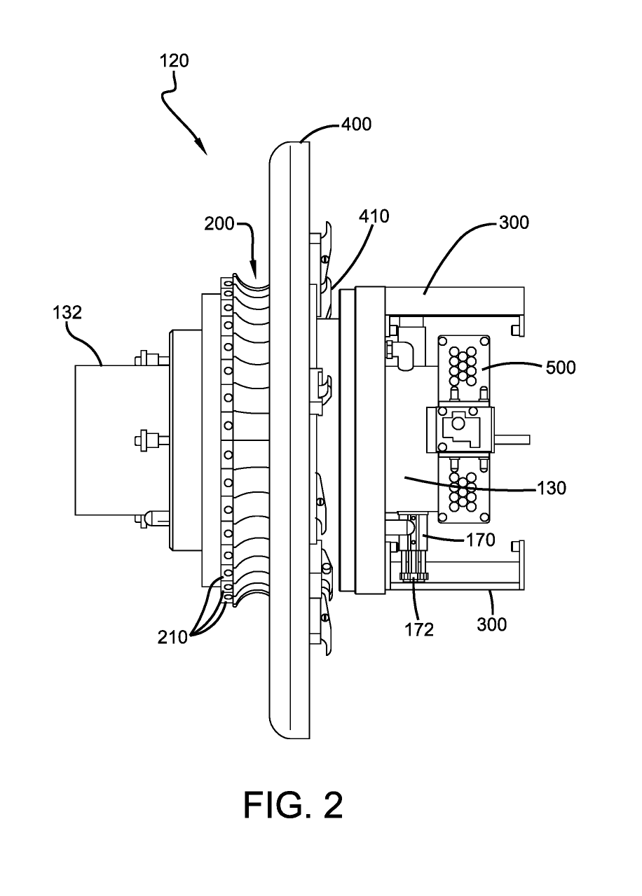

FIGS. 1-6 illustrate that the hubs 120 may further include an optional shaping plate 400. The optional shaping plate 400 is received in support brackets 410, as shown in FIG. 2. The optional shaping plate 400 may assist the shaping process by engaging the mid sidewall of the tire during the shaping process. The air pressure in the cylinder mover for shaping plate 400 can be variably controlled.

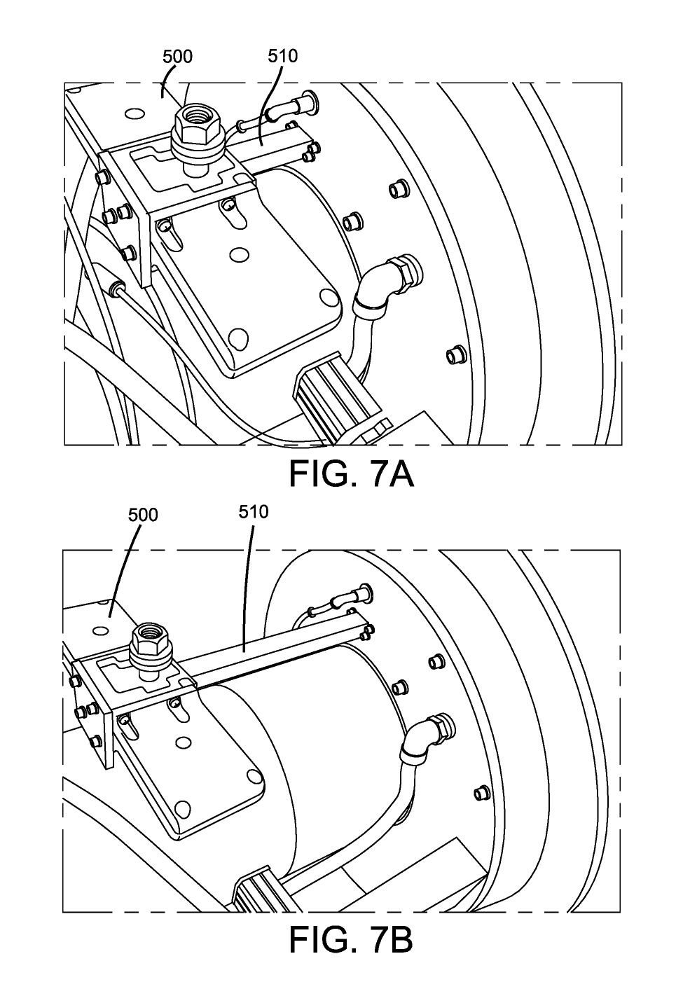

FIGS. 7A illustrates a retraction mechanism 500 that is useful to reposition the sliding sleeve in the desired axial location. The retraction mechanism 500 includes a chain attached to the sliding sleeve to slide the sleeve into the home or start position. The retraction mechanism 500 is mounted on the stationary sleeve housing 130.

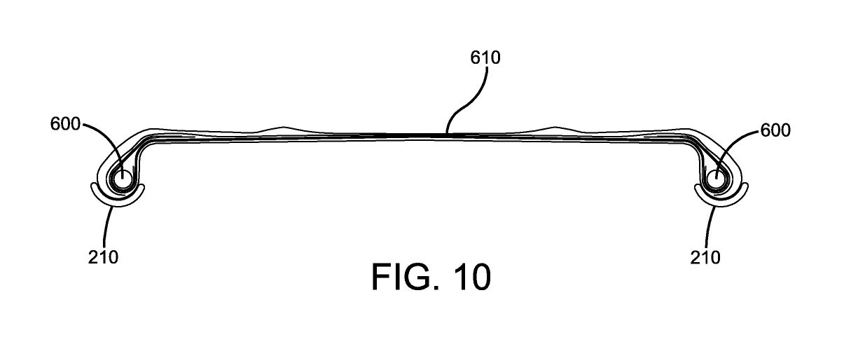

The first step of the catenary method of building tires begins with the tire building drum located in the start position as shown in FIG. 1. The sliding sleeve 140 is locked to the inner stationary sleeve 130. A cylindrically shaped green tire carcass 610 is mounted on the bead mechanisms 200 on each hub 120, so that a respective bead area 600 is received in the bead pocket 210 of a respective hub, as shown in FIG. 9 and FIG. 10.

The bead locking mechanisms 200 may optionally be radially expanded to exert a low pressure force on the beads. As distinguished from the prior art drums, exact placement of the carcass beads over the bead pockets is not required, nor is exact bead pocket location. As soon as the inflation process starts, the beads are able to pull towards the centerline of the carcass, thereby becoming centered and symmetrical to the bead pockets. As the catenary shaping of the carcass begins, the beads are freely able to move, and the carcass cord tension is very low. If the beads cannot move as in prior art drums, then the cord path is straight and horizontal, while the cord tension undesirably increases exponentially. If the bead pockets are expanded with too much force then the beads cannot move towards the inside edge of the pocket as needed and the carcass cannot become centered to the drum. Thus, the bead pocket force is preferably zero or minimal.

After the green tire carcass is loaded, the next step is to shape the green carcass using the catenary shaping process of the invention. As the tire drum rotates, the green carcass 610 is slowly inflated using low pressure, high volume shaping air. The locking member 172 is unlocked from the retaining member 300, allowing the sliding sleeve 140 to freely slide axially inward towards the adjacent hub. During inflation, the carcass cord tension is maintained at a low tension due to the evolvement of the catenary shape and the free sliding movement of the beads mounted on the sliding sleeves, which are each free to move in the axial direction. The shaping air pressure is very low at the level needed to gently strain and overcome the carcass composite stiffness. The carcass is self shaping itself to the balanced catenary shape. Thus each sliding sleeve is free to move in the axial direction towards the other sliding sleeve so that the tire is shaped by the tension of the ply cords as shown in FIG. 10. Typically, each sliding sleeve may axially slide in the range of 6 to 10 inches. The shape of the bead pocket segments allow the tire bead area to rotate during shaping without the need for high bead clamping forces. The bead lock forces can be zero or be minimal.

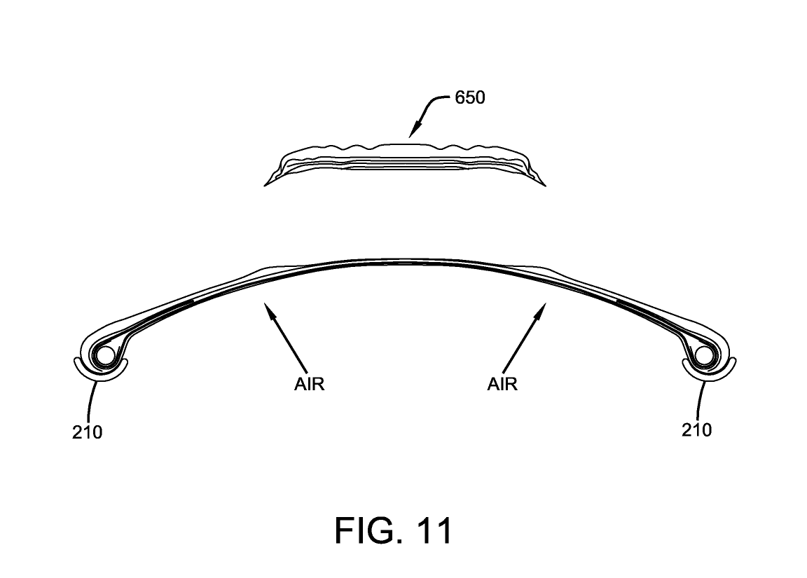

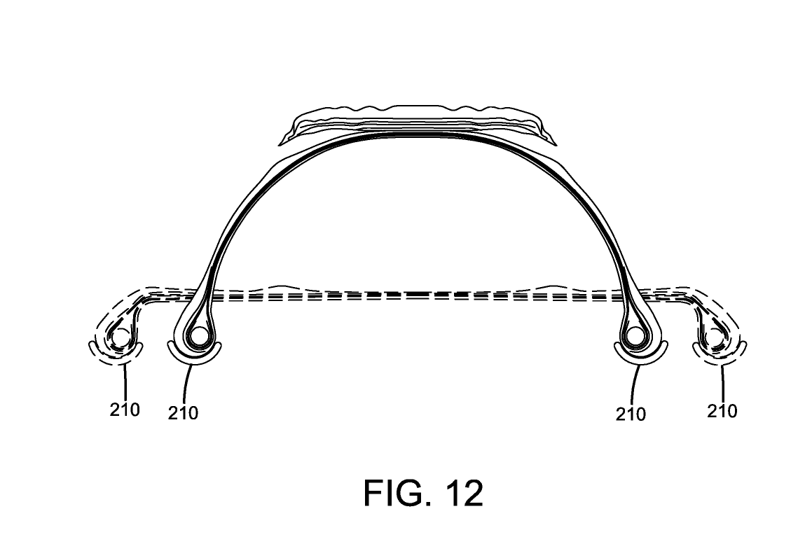

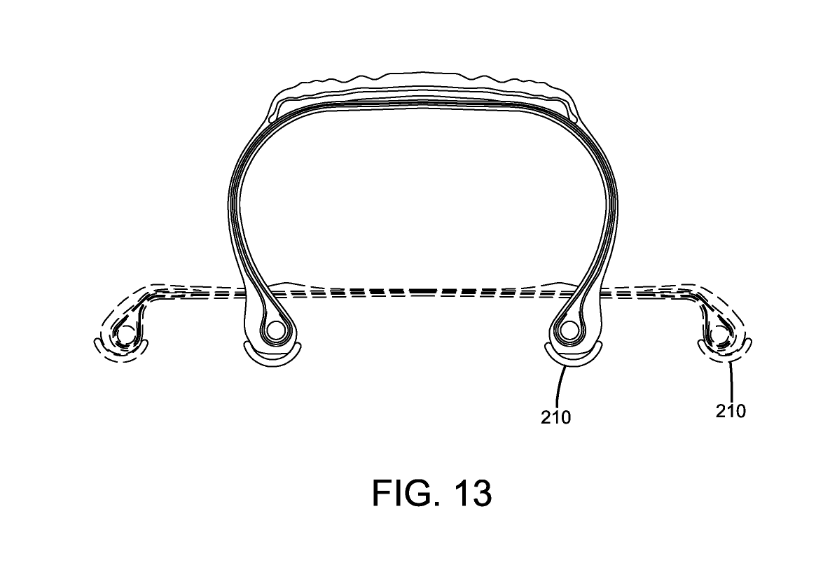

The assembled belt and tread package 650 is positioned over the inflating carcass 600 as shown in FIG. 11. The carcass 600 expands into the assembled belt and tread package 650 as shown in FIG. 12. The carcass is inflated using high volume, low pressure air. The pressure preferably does not exceed 280 mbar, and is preferably in the range of 210-280 mbar. The flow rate is increased from prior art process so that the system flow coefficient Cv rate is about 10. After the tire is approximately 80% of the desired shape, the carcass will be stabilized in the catenary shape such that the beads are without any horizontal reaction, and the sidewall and bead are at the inflection point of direction reversal, and the carcass centerline has contacted the belt and tread package centerline. One the carcass has been stabilized in the catenary shape, then the hubs are then locked to the drive mechanism and slowly moved axially inward using the screw until the desired axial width of the tire is achieved and the apex is approximately at the cured ply line angle. Next, the tread and shoulder area is stitched to the carcass using low stitching pressure (not shown). The pressure in the carcass is in the range of 350 to 800 mbars, more preferably in the range of 500-700 mbars. The stitcher cylinder pressure (not shown) is adjusted to not overly deform the carcass, using low pressure, starting at the center of the tread and stitching the tread in a circumferential manner, shifting axially outward from the center of the tire. The stitcher also stitches the tread shoulder interface and shoulder area. The completed tire is shown in FIG. 13, and the initial green tire carcass is shown in phantom.

Then the tire is removed from the tire building drum completing the process. The green tire is then cured in a conventional mold.

In an alternate embodiment of the invention, only one of the hubs has a sliding sleeve.

In an alternate embodiment of the invention, one of the hubs does not move in the axial direction and has no sliding sleeve.

The advantage of the catenary shaping process is that it does not produce any “ply pull through” into the squeegee and inner liner. The catenary shaping process allows the beads to move as need and the low bead locking force allow the rotation of the cable bead outer lang wire around the core wires of the cable bead. The plies then tacked to the outer lang wire are free to rotate along with the outer lang wires. There is no elastic energy in the outer lang wire when the wire is rotated so the ending rotational angle of the bead carcass elements is saved. Another advantage to the catenary shaping process is the tire is the carcass is shaped on a “pneumatic core” to within approximately 4% of the final molded shape, closely approximating a tire that has been made on a core.

While certain representative embodiments and details have been shown for the purpose of illustrating the invention, it will be apparent to those skilled in this art that various changes and modifications may be made therein without departing from the spirit or scope of the invention.

What is claimed is:

1. A method of forming a tire on a tire building drum from a green tire carcass, the method comprising the steps of:
applying the green tire carcass onto the tire building drum by placing a first and second bead onto a first and second bead receiving member of the tire building drum, wherein no bead locking force is utilized;
inflating the carcass into engagement with a belt and tread package while at least one of the beads is free to move axially inward.

2. The method of claim 1 wherein both of the beads are free to move axially inward.

3. The method of claim 1 wherein at least one of the beads is slidable in the axial direction during the inflation step.

4. The method of claim 1 further including the step of radially expanding a first and second bead receiving member into engagement with a respective first and second bead at a low pressure.

5. The method of claim 1 wherein the carcass is inflated with high volume airflow.

6. The method of claim 5 wherein the carcass is inflated with airflow having a flow coefficient Cv of 2 or more.

7. The method of claim 5 wherein the carcass is inflated with airflow having a flow coefficient Cv of 5 to 10.

8. The method of claim 1 wherein the carcass in inflated with high volume airflow.

9. The method of claim 1 wherein the carcass in inflated with low pressure airflow.

10. A method of forming a tire on a tire building drum comprising the steps of:
applying a green tire carcass onto the tire building drum by placing a first and second bead onto a first and second respective bead pocket of the tire building drum, wherein low bead locking force is utilized;
wherein at least one of the first and second respective bead pockets are configured for unconstrained sliding in the axial direction;
inflating the carcass into engagement with a belt and tread package while the at least one of the bead pockets is free to slide axially inward.
